(19) United States
(12) Patent Application Publication
(10) Pub. No.: US 2025/0094251 A1
(43) Pub. Date: Mar. 20, 2025

(54) SYSTEMS AND METHODS FOR PROVIDING A MIDDLE-TIER FRAMEWORK

(71) Applicant: JPMORGAN CHASE BANK, N.A., New York, NY (US)

(72) Inventors: Lakshmi POLAVARAPU, Frisco, TX (US); Venkata SANKARA, Monroe Township, NJ (US); Kevin SHEEHAN, Glen Rock, NJ (US)

(21) Appl. No.: 18/470,967

(22) Filed: Sep. 20, 2023

(51) Int. Cl. G06F 9/54; G06F 16/25

(52) U.S. Cl. CPC G06F 9/543; G06F 16/25

(57) ABSTRACT

In some aspects, the techniques described herein relate to a method including: receiving, at an application programming interface (API) of a middle-tier platform, an initial API method call including a request identifier associated with a processing request and a data parameter; writing the data parameter and the request identifier to a record of a datastore, wherein the record of the datastore includes a batch field; writing a value of false to the batch field; executing, by a first intermediary processing procedure, a query of the datastore, wherein the query of the datastore retrieves the record of the datastore; performing, by a second intermediary processing procedure, additional intermediary processing; making a secondary API call to a backend system; receiving a second data parameter from the backend system in response to the secondary API call; and generating a response to the processing request.

### BACKGROUND

### 1. Field of the Invention

Aspects generally relate to systems and methods for providing a middle-tier framework.

### 2. Description of the Related Art

Enterprise-level organizations often provide and/or manage several backend processing systems that are instrumental in providing services to the organization's customers. Some backend systems may be proprietary and other backend systems may be provided by third parties. In isolated environments, these backend systems may be independent of each other in terms of access interfaces, interface requirements, dependencies, etc. These systems may also be independent of each other in terms of maintenance, updates, windows of downtime, etc. In order to provide users with seamless and unified access to various backend processing systems, a robust middle-tier platform is required in order to coordinate processing requests, particularly processing requests where delayed processing may be a factor.

### SUMMARY

In some aspects, the techniques described herein relate to a method including: receiving, at an application programming interface (API) of a middle-tier platform, an initial API method call including a request identifier associated with a processing request and a data parameter; writing the data parameter and the request identifier to a record of a datastore, wherein the record of the datastore includes a batch field; writing a value of false to the batch field; executing, by a first intermediary processing procedure, a query of the datastore, wherein the query of the datastore retrieves the record of the datastore; performing, by a second intermediary processing procedure, additional intermediary processing; making a secondary API call to a backend system; receiving a second data parameter from the backend system in response to the secondary API call; and generating a response to the processing request.

In some aspects, the techniques described herein relate to a method, wherein the first intermediary processing procedure is a batch process.

In some aspects, the techniques described herein relate to a method, wherein the first intermediary processing procedure updates the batch field to a value of true before completing execution.

In some aspects, the techniques described herein relate to a method, wherein the query of the datastore includes the request identifier and the value of false to the batch field as lookup parameters of the query.

In some aspects, the techniques described herein relate to a method, wherein the initial API method call is received from a user interface.

In some aspects, the techniques described herein relate to a method, wherein a user interface object is associated with the initial API method call.

In some aspects, the techniques described herein relate to a method, wherein a user activation of the user interface object initiates the initial API method call.

In some aspects, the techniques described herein relate to a system including at least one computer including a processor, wherein the at least one computer is configured to: receive, at an application programming interface (API) of a middle-tier platform, an initial API method call including a request identifier associated with a processing request and a data parameter; write the data parameter and the request identifier to a record of a datastore, wherein the record of the datastore includes a batch field; write a value of false to the batch field; execute, by a first intermediary processing procedure, a query of the datastore, wherein the query of the datastore retrieves the record of the datastore; perform, by a second intermediary processing procedure, additional intermediary processing; make a secondary API call to a backend system; receive a second data parameter from the backend system in response to the secondary API call; and generate a response to the processing request.

In some aspects, the techniques described herein relate to a system, wherein the first intermediary processing procedure is a batch process.

In some aspects, the techniques described herein relate to a system, wherein the first intermediary processing procedure updates the batch field to a value of true before completing execution.

In some aspects, the techniques described herein relate to a system, wherein the query of the datastore includes the request identifier and the value of false to the batch field as lookup parameters of the query.

In some aspects, the techniques described herein relate to a system, wherein the initial API method call is received from a user interface.

In some aspects, the techniques described herein relate to a system, wherein a user interface object is associated with the initial API method call.

In some aspects, the techniques described herein relate to a system, wherein a user activation of the user interface object initiates the initial API method call.

In some aspects, the techniques described herein relate to a non-transitory computer readable storage medium, including instructions stored thereon, which instructions, when read and executed by one or more computer processors, cause the one or more computer processors to perform steps including: receiving, at an application programming interface (API) of a middle-tier platform, an initial API method call including a request identifier associated with a processing request and a data parameter; writing the data parameter and the request identifier to a record of a datastore, wherein the record of the datastore includes a batch field; writing a value of false to the batch field; executing, by a first intermediary processing procedure, a query of the datastore, wherein the query of the datastore retrieves the record of the datastore; performing, by a second intermediary processing procedure, additional intermediary processing; making a secondary API call to a backend system; receiving a second data parameter from the backend system in response to the secondary API call; and generating a response to the processing request.

In some aspects, the techniques described herein relate to a non-transitory computer readable storage medium, wherein the first intermediary processing procedure is a batch process.

In some aspects, the techniques described herein relate to a non-transitory computer readable storage medium, wherein the first intermediary processing procedure updates the batch field to a value of true before completing execution.

In some aspects, the techniques described herein relate to a non-transitory computer readable storage medium, wherein the query of the datastore includes the request identifier and the value of false to the batch field as lookup parameters of the query.

In some aspects, the techniques described herein relate to a non-transitory computer readable storage medium, wherein the initial API method call is received from a user interface.

In some aspects, the techniques described herein relate to a non-transitory computer readable storage medium, wherein a user interface object is associated with the initial API method call, and wherein a user activation of the user interface object initiates the initial API method call.

### BRIEF DESCRIPTION OF THE DRAWINGS

FIG. 1 is a block diagram of a system for providing a middle-tier platform, in accordance with aspects.

FIG. 2 is a logical flow of a middle-tier platform, in accordance with aspects.

FIG. 3 is a block diagram of a technology infrastructure and computing device for implementing certain aspects of the present disclosure, in accordance with aspects.

### DETAILED DESCRIPTION

Aspects generally relate to systems and methods for providing a middle-tier framework.

Aspects may provide a middle-tier platform for receiving an application programming interface (API) call including parameters, where the parameters may be included in a secondary API call to a backend system. The middle-tier platform may write the received parameters to a datastore and determine intermediary processing procedures and/or any processing delays associated with the called API method. The middle-tier platform may perform or invoke intermediary processing tasks based on the stored parameters and/or the secondary API call to the backend system. An intermediary processing task may generate additional parameters that may be stored in the datastore with a relationship to the original parameters. The middle-tier platform may, after execution of determined intermediary processing procedures/tasks and expiration of any processing delay, pass a set of parameters to a backend system via a secondary API call to the backend system.

An organization that implements the techniques described herein (an implementing organization) may provide (or provide access to) several backend processing systems, where each provided backend processing system provides a service to a customer of the implementing organization. While customers may require access to several backend system processes, an implementing organization may wish to provide unified and simplified access to the processes performed by backend systems. Additionally, implementing organizations may wish to minimize a customer's workload and maintain a coordination layer between the customer (with access via a front-end interface) and backend processing systems. A middle-tier platform may determine and perform intermediary processing tasks that backend tasks may depend on and/or handle processing interruptions that may be experienced due to unavailability of a backend processes or delays in responses from intermediary processes.

An exemplary implementing organization may be a financial institution. A financial institution may offer customers access to several backend transaction processing systems. Exemplary backend systems may be payment processing systems, loan servicing systems, loan application systems, etc. Each of these systems, while related at a logical level (i.e., they may each be used in relation to a customer's loan), may be independent of the others in terms of processing and data dependencies, scheduled downtime, etc. A middle-tier platform may allow customers to perceive various transaction requests handled by the disparate systems as tightly integrated. A robust middle-tier platform that is configured to receive parameters from a unified front-end interface and manage intermediary processing tasks and other processing delays may provide customers with unified and simplified access to a multitude of processing services.

Moreover, a middle-tier platform may act as a centralized repository for processing requests. In the exemplary case of a financial institution, each received transaction may be written to a datastore and may be persisted indefinitely. The datastore may then be used as a source of data for analytics, machine learning operations, reporting, etc., in addition to providing a non-volatile store where parameters may be held, created, and updated during intermediary processing or processing delays.

In accordance with aspects, an implementing organization may provide a front-end interface configured to receive customer input. A front-end interface may be a webpage provided by a webserver of an implementing organization. A front-end interface may also be provided through a computer application (e.g., a mobile application), or through any suitable means. A customer may select one or more processing requests from a front-end interface and may further provide required data parameters through the interface (e.g., via a text field, a drop-down box, or some other user interface object). Additionally, parameters may be collected based on a user context that is created or retrievable based on a user authenticating via the front-end interface (e.g., a customer identifier, an account number, etc.).

In accordance with aspects, a middle-tier platform may provide an API gateway that receives API method calls from a front-end interface. The API gateway may act as a central API and expose several initial API methods. A front-end interface may be configured to call an initial API method of a middle-tier platform based on a part of the front-end interface that a user interacts with. For instance, an initial API method signature may be embedded in an action of an interface object (e.g., an “onClick” action of a “button” object of a graphical user interface). When a user activates the interface object (e.g., “clicks” the button in the interface), the method may be called, and collected parameters may be passed to a middle-tier platform as parameters of the called initial API method. Initial API methods may be configured, directly or indirectly, to call secondary API methods, which secondary API methods may be API methods exposed by various backend processing systems. Prior to making secondary API calls, however, a middle-tier platform may perform intermediary processing tasks and/or make checks to determine that any processing delays have passed.

In accordance with aspects, a middle-tier platform may expose a number of initial API methods to a user interface. Each API method exposed by a middle-tier platform may be an initial API method in that it may be associated with a secondary API method exposed by a backend processing system. Each initial API method may perform intermediary processing tasks or procedures before an associated secondary API method is called and parameters are passed to a backend processing system. In some aspects, an initial API method may be configured to write received parameters to a datastore. Writing received parameters to a datastore provides non-volatile storage of received parameters. Accordingly, intermediary processing procedures may query a datastore and retrieve parameters received by a middle-tier environment after the parameters are no longer held in volatile memory. This facilitates delayed processing of the parameters in the event that a processing delay is encountered (e.g., backend system downtime, delayed response from intermediary processing procedure, etc.) and the ability for several intermediary processing procedures to be executed before passing of parameters to a backend processing system.

In accordance with aspects, data parameters may be written to a datastore such that a data record for a set of received parameters indicates a context and/or state of the parameters. A datastore may define a corresponding data record schema or format for each initial API method that is exposed by a middle-tier platform. For instance, referencing an exemplary financial institution that may be an implementing organization, a database record for an exposed API method for making a loan payment may include data fields that record a loan number, a payment amount, a pay-by date, etc. With continued reference to an implementing financial institution, a database record that corresponds to a loan application may include data fields that record an applicant, a loan amount, a credit rating of an applicant, a gross revenue of an applicant, an average monthly cash flow of an applicant, etc.

In accordance with aspects, a datastore of a middle-tier platform may also include universal data fields, i.e., fields that are present in the data record regardless of a corresponding API method signature. In some aspects, a data record may be designed to be used with/by a particular set of intermediary processes (e.g., batch jobs that are executed as intermediary processing procedures). Which data fields a particular type of data record includes may further be based on a secondary API call associated with an initial API call, parameters required by a secondary API call that must be generated or transformed through intermediary processing procedures, a type of intermediary process that executes on data in a data record, etc. Universal data fields or data fields that are used with particular intermediary processing procedures may be used to determine a context and/or state of parameters stored in a data record.

In accordance with aspects, a data record may be designed for use with a batch process. For instance, a data record may include a batch flag and a lock flag. A batch flag and a lock flag may be a binary value (i.e., 1 or 0, yes or no, true or false, etc.). A middle-tier environment may persist parameters received from an initial API method call to a record of a datastore, where the record includes a lock field and a batch field. At an initial write, both the batch field and the lock field may be set to false (or some other value that indicates “false”). A batch process may query the datastore on a periodic basis for each record having a batch flag with a value of false. For each record with a value of false returned by a query of the datastore, a batch process may execute an intermediary processing procedure.

In accordance with aspects, a batch process may be configured to retrieve records stored by an initial API method to a datastore and execute one or more intermediary processes for each record that is retrieved by the query of the datastore. A batch process may be associated with a request identifier. A request identifier may associate initial API methods and intermediary processing procedures with secondary API methods and/or backend system processing procedures. An initial API may be configured to write parameters to a middle-tier datastore with a relationship to a request identifier (e.g., a key or table relationship). A batch process may be associated with a request identifier by being configured to query records from a middle-tier data store that have a relation to the request identifier (e.g., a key or table relationship). Accordingly, when a batch process that is associated with a request identifier executes, it may query records from a datastore using the request identifier that the batch process is associated with as a lookup key (in addition to records that have a batch flag value of false). The query may return data, including received parameters, from records that 1) have a batch flag value of false, 2) have a lock flag value of false, and 3) are persisted with a relationship to the associated request identifier (i.e., can be retrieved using the request identifier as a lookup parameter/key).

A batch process may begin processing by updating a lock flag of a retrieved record to true so that the database record remains locked until the batch process is complete. The batch process may then execute or initiate execution of one or more intermediary processing procedures. Exemplary intermediary processing procedures may include generation of additional data parameters based on received data parameters or based on an associated request identifier, performing checks of backend systems to determine if a backend system is online and accessible, etc. For instance, given an exemplary user request for a cash advancement against a line of credit, intermediary process procedures carried out or initiated by a batch process may include checking a credit line balance of the associated user/entity to determine that the advance may be made, and sending a request to a treasury department to retrieve approval for the advance.

In accordance with aspects, intermediary processing procedures may have dependencies on other intermediary processing procedures, and intermediary processing may stop if a dependency condition is not met. For instance, if a user request is for a cash advancement, and an intermediary processing procedure that determines a credit balance of an associated user's credit account is not high enough to meet the requested amount of the advance, then processing may stop, and an update indicating the result may be returned to the user (e.g., via the user interface, or some out of band channel such as via electronic mail). Moreover, data that is determined, retrieved, and/or generated by an intermediary processing procedure may be persisted to a request's corresponding record in a middle-tier datastore.

Continuing with an exemplary cash advancement intermediary processing procedure, if it is determined that a customer has (or does not have) a sufficient credit balance for a requested advance, the determination may be written as a value (e.g., a binary value) in a corresponding data field of a corresponding data record. A subsequent intermediary processing procedure, which may depend on the prior procedure's determination, may then use the persisted value in further processing. That is, an intermediary processing procedure that requests approval for a cash advancement that is over a certain amount may query a middle-tier datastore to determine a value that indicates whether a customer has a sufficient credit balance. If the value indicates that a customer does have a sufficient credit balance, then the approval request procedure may be executed. Otherwise, a response indicating insufficient credit balance may be sent to the requesting customer via a front-end interface and processing at the middle-tier platform may end.

In accordance with aspects, a batch process may end when all intermediary processing procedures associated with the batch process have been completed. A batch process may update a lock flag value to false and may update a batch flag value to true for a data record before ending a batch procedure. A batch flag updated to a true value may be an indication to any subsequent intermediary processing procedures that a related batch process has finished. A batch flag updated to a true value may also prevent a batch process from being duplicated for a given record, because the record will not be returned in queries configured to return records having a batch value of false.

In accordance with aspects, an intermediary processing procedure may call a secondary API method exposed by a backend processing system and may pass data parameters stored in a middle-tier datastore to the secondary API method. The secondary API method may be called by a batch bob (e.g., as a final intermediary processing procedure that is initiated by the batch job). In other aspects, logic executed by an initial API method may call a secondary API method before the logic terminates. A secondary API method may take specified parameters, which parameters may be stored in and retrieved from a datastore of a middle-tier platform. A secondary API method may return a response from a backend process to the caller. A response may include additional data parameters that may be saved with a corresponding record in a datastore o fa middle-tier platform and may be returned to a front-end interface by the middle tier platform for user consumption.

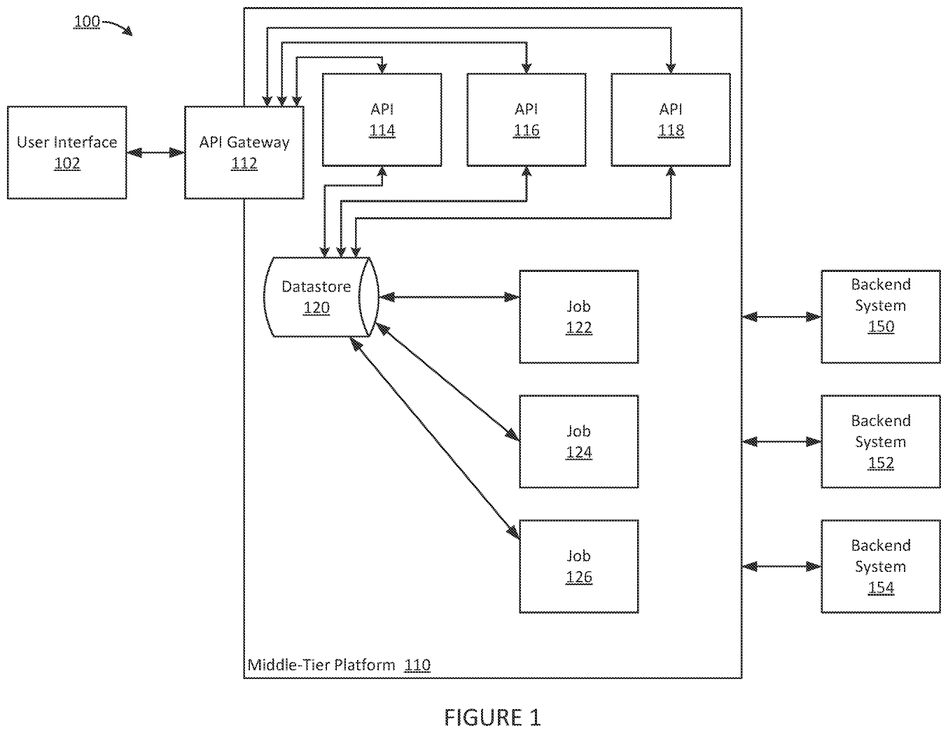

FIG. 1 is a block diagram of a system for providing a middle-tier platform, in accordance with aspects. System 100 includes user interface 102, middle-tier platform 110, backend system 150, backend system 152, and backend system 154. Middle-tier platform 110 includes API gateway 112, API 114, API 116, and API 118. Middle-tier platform 110 further includes datastore 120, job 122, job 124, and job 126. Middle-tier platform 110, backend system 150, backend system 152, and backend system 154 may each be part of a providing organization's technology infrastructure. In some aspects, backend systems such as backend system 150, backend system 152, and backend system 154 may be provided and managed by a third-party as a part of the third party's technology infrastructure.

API gateway 112 may provide user interface 102 access to API 114, API 116, and API 118. User interface 102 may be part of a client application that executes on a client device. User interface 102 may be in operative communication with API gateway 112 via a private or public computer network. API method calls made by user interface 102 may be directed to API gateway 112, and API gateway 112 may receive API method calls made by user interface 102 and forward the calls including any received parameters to a corresponding API for processing. For instance, API gateway 112 may receive a method call to a method published by API 114 and may forward the call including data parameters to API 114.

Each of API 114, API 116, and API 118 may publish or expose one or more initial API methods. User interface objects included in user interface 102 may be associated with method signatures of corresponding methods published by an API of middle-tier platform 110. For instance, a user may provide user input to user interface 102 and activate an interface object such as a button. Activation of a user interface object may call the method associated with the interface object and send data parameters collected from user interface 102 to API gateway 112. API gateway 112 may forward method calls to API 114, API 116, or API 118, as appropriate. Although only three APIs are depicted in FIG. 1, it is contemplated that middle-tier platform 110 may publish as many APIs as is necessary or desirable for a particular aspect.

Once received by one of API 114, API 116, or API 118, the data parameters may be written to datastore 120. Data parameters may be written to a storage schema that is designed to store data parameters that are associated with a particular API. For instance, an API method of API 114 may store received parameters in a corresponding storage configuration that may be different than a storage configuration that is used to store parameters associated with a method published by API 116. Storage configurations/schemas are discussed in more detail, herein. Datastore 120 may be any suitable datastore (e.g., a relational database, a key-value pair, a data warehouse, etc.).

Each of job 122, job 124, and job 126 are intermediary processing procedures. Job 122, job 124, and job 126 represent any intermediary process that may be executed by middle-tier platform 110. Job 122, job 124, and job 126 may be services, as described herein. In an exemplary aspect, job 122 may be a batch job, as described in more detail, herein. As a batch job, job 122 may invoke other intermediary processes, such as job 124 and/or job 126. Job 122 may begin processing by querying datastore 120, retrieving necessary parameters, and initiating additional intermediary processing procedures. As a batch job, job 122 may execute periodically (i.e., every several minutes, once an hour, etc.). Job 122 may query datastore 120 for any record that has a particular request identifier, that has a batch flag value of false, and that has a lock flag value of false—these parameters indicate association of a returned record to job 122, that the record has not previously been processed by job 122, and that the record is not currently locked (respectively).

As a batch job, job 122 may call other processes, such as job 124 and job 126. 124 and/or job 126 may receive parameters from datastore 120 (either from job 122 or from a direct query) and may generate other parameters and persist generated parameters to an associated datastore record. They may use, e.g., a transaction identifier, a unique user identifier, or other unique lookup value to persist data to a corresponding record. Intermediary processes, such as job 122, job 124, and job 126 may have dependencies on other intermediary processing procedures and may execute to completion only when a dependency check has indicated that other processing dependencies have been met.

When all intermediary processing procedures have completed execution, middle-tier platform 110 may call a secondary API method of a backend processing system, such as backend system 150, backend system 152, or backend system 154. A secondary API method may be identified by a request identifier that is associated with a request. A secondary API method may be called by an intermediate processing procedure (such as job 122, job 124, or job). In accordance with aspects, a calling procedure may wait for a response from a called secondary API method of a backend system. A calling procedure may write any new data parameters received from a backend system to datastore 120. A calling procedure, or another procedure of middle-tier platform 110 may send a response to a user via user interface 102. In some aspects, particularly where there will be a processing delay (such as for delayed responses, backend system downtime, etc.), middle-tier platform 110 may respond via an out-of-band channel, such as via email.

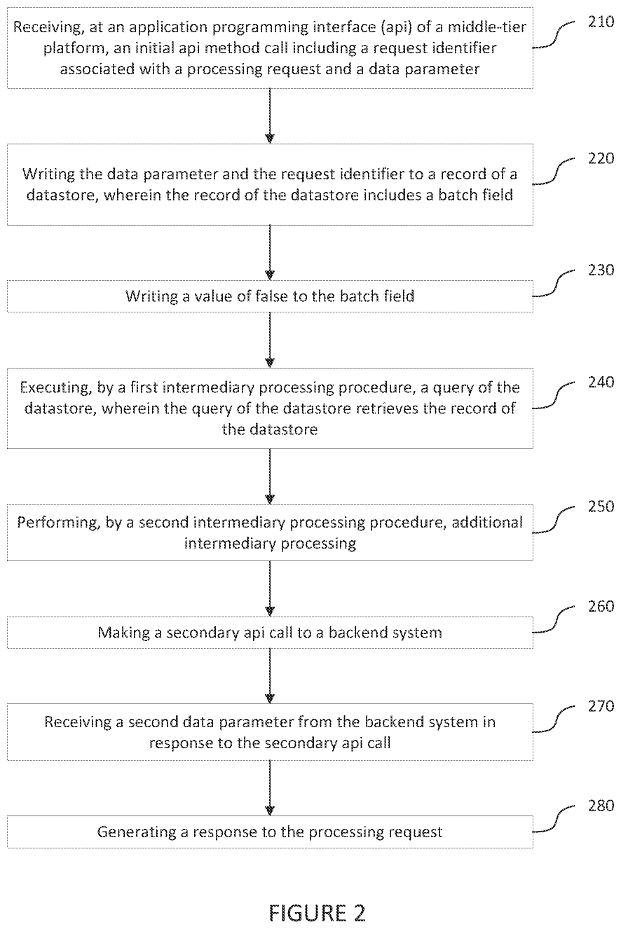

FIG. 2 is a logical flow of a middle-tier platform, in accordance with aspects.

Step 210 includes receiving, at an application programming interface (API) of a middle-tier platform, an initial API method call including a request identifier associated with a processing request and a data parameter.

Step 220 includes writing the data parameter and the request identifier to a record of a datastore, wherein the record of the datastore includes a batch field]

Step 230 includes writing a value of false to the batch field.

Step 240 includes executing, by a first intermediary processing procedure, a query of the datastore, wherein the query of the datastore retrieves the record of the datastore.

Step 250 includes performing, by a second intermediary processing procedure, additional intermediary processing.

Step 260 includes making a secondary API call to a backend system.

Step 270 includes receiving a second data parameter from the backend system in response to the secondary API call.

Step 280 includes generating a response to the processing request.

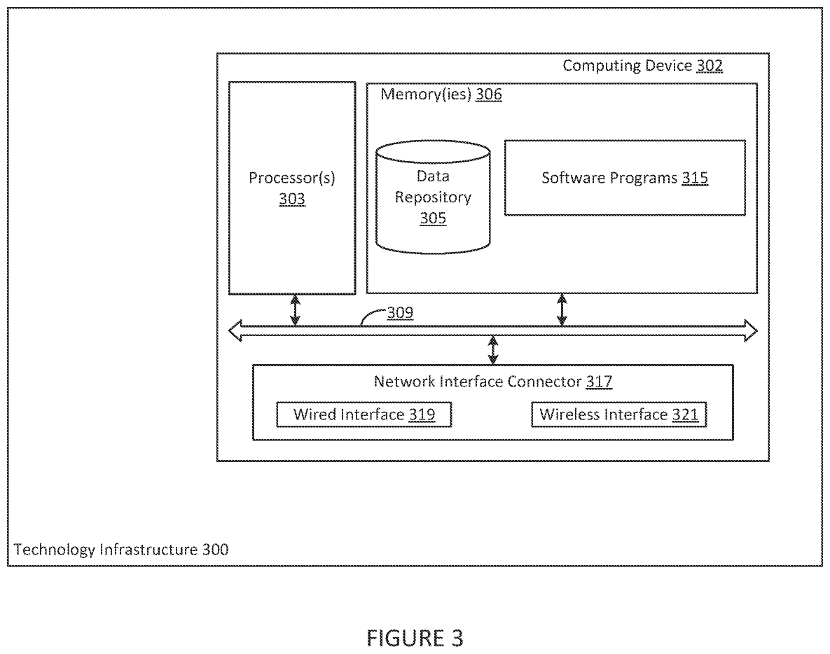

FIG. 3 is a block diagram of a technology infrastructure and computing device for implementing certain aspects of the present disclosure, in accordance with aspects. FIG. 3 includes technology infrastructure 300. Technology infrastructure 300 represents the technology infrastructure of an implementing organization. Technology infrastructure 300 may include hardware such as servers, client devices, and other computers or processing devices. Technology infrastructure 300 may include software (e.g., computer) applications that execute on computers and other processing devices. Technology infrastructure 300 may include computer network mediums, and computer networking hardware and software for providing operative communication between computers, processing devices, software applications, procedures and processes, and logical flows and steps, as described herein.

Exemplary hardware and software that may be implemented in combination where software (such as a computer application) executes on hardware. For instance, technology infrastructure 300 may include webservers, application servers, database servers and database engines, communication servers such as email servers and SMS servers, client devices, etc. The term “service” as used herein may include software that, when executed, receives client service requests and responds to client service requests with data and/or processing procedures. A software service may be a commercially available computer application or may be a custom-developed and/or proprietary computer application. A service may execute on a server. The term “server” may include hardware (e.g., a computer including a processor and a memory) that is configured to execute service software. A server may include an operating system optimized for executing services. A service may be a part of, included with, or tightly integrated with a server operating system. A server may include a network interface connection for interfacing with a computer network to facilitate operative communication between client devices and client software, and/or other servers and services that execute thereon.

Server hardware may be virtually allocated to a server operating system and/or service software through virtualization environments, such that the server operating system or service software shares hardware resources such as one or more processors, memories, system buses, network interfaces, or other physical hardware resources. A server operating system and/or service software may execute in virtualized hardware environments, such as virtualized operating system environments, application containers, or any other suitable method for hardware environment virtualization.

Technology infrastructure 300 may also include client devices. A client device may be a computer or other processing device including a processor and a memory that stores client computer software and is configured to execute client software. Client software is software configured for execution on a client device. Client software may be configured as a client of a service. For example, client software may make requests to one or more services for data and/or processing of data. Client software may receive data from, e.g., a service, and may execute additional processing, computations, or logical steps with the received data. Client software may be configured with a graphical user interface such that a user of a client device may interact with client computer software that executes thereon. An interface of client software may facilitate user interaction, such as data entry, data manipulation, etc., for a user of a client device.

A client device may be a mobile device, such as a smart phone, tablet computer, or laptop computer. A client device may also be a desktop computer, or any electronic device that is capable of storing and executing a computer application (e.g., a mobile application). A client device may include a network interface connector for interfacing with a public or private network and for operative communication with other devices, computers, servers, etc., on a public or private network.

Technology infrastructure 300 includes network routers, switches, and firewalls, which may comprise hardware, software, and/or firmware that facilitates transmission of data across a network medium. Routers, switches, and firewalls may include physical ports for accepting physical network medium (generally, a type of cable or wire—e.g., copper of fiber optic wire/cable) that forms a physical computer network. Routers, switches, and firewalls may also have “wireless” interfaces that facilitate data transmissions via radio waves. A computer network included in technology infrastructure 300 may include both wired and wireless components and interfaces and may interface with servers and other hardware via either wired or wireless communications. A computer network of technology infrastructure 300 may be a private network but may interface with a public network (such as the internet) to facilitate operative communication between computers executing on technology infrastructure 300 and computers executing outside of technology infrastructure 300.

FIG. 3 further depicts exemplary computing device 302. Computing device 302 depicts exemplary hardware that executes the logic that drives the various system components described herein. Servers and client devices may take the form of computing device 302. While shown as internal to technology infrastructure 300, computing device 302 may be external to technology infrastructure 300 and may be in operative communication with a computing device internal to technology infrastructure 300.

In accordance with aspects, system components such as an API, an intermediary processing procedure, a backend system, client devices, servers, various database engines and database services, and other computer applications and logic may include, and/or execute on, components and configurations the same, or similar to, computing device 302.

Computing device 302 includes a processor 303 coupled to a memory 306. Memory 306 may include volatile memory and/or persistent memory. The processor 303 executes computer-executable program code stored in memory 306, such as software programs 315. Software programs 315 may include one or more of the logical steps disclosed herein as a programmatic instruction, which can be executed by processor 303. Memory 306 may also include data repository 305, which may be nonvolatile memory for data persistence. The processor 303 and the memory 306 may be coupled by a bus 309. In some examples, the bus 309 may also be coupled to one or more network interface connectors 317, such as wired network interface 319, and/or wireless network interface 321. Computing device 302 may also have user interface components, such as a screen for displaying graphical user interfaces and receiving input from the user, a mouse, a keyboard and/or other input/output components (not shown).

In accordance with aspects, services, modules, engines, etc., described herein may provide one or more application programming interfaces (APIs) in order to facilitate communication with related/provided computer applications and/or among various public or partner technology infrastructures, data centers, or the like. APIs may publish various methods and expose the methods, e.g., via API gateways. A published API method may be called by an application that is authorized to access the published API method. API methods may take data as one or more parameters or arguments of the called method. In some aspects, API access may be governed by an API gateway associated with a corresponding API. In some aspects, incoming API method calls may be routed to an API gateway and the API gateway may forward the method calls to internal services/modules/engines that publish the API and its associated methods.

A service/module/engine that publishes an API may execute a called API method, perform processing on any data received as parameters of the called method, and send a return communication to the method caller (e.g., via an API gateway). A return communication may also include data based on the called method, the method's data parameters and any performed processing associated with the called method.

API gateways may be public or private gateways. A public API gateway may accept method calls from any source without first authenticating or validating the calling source. A private API gateway may require a source to authenticate or validate itself via an authentication or validation service before access to published API methods is granted. APIs may be exposed via dedicated and private communication channels such as private computer networks or may be exposed via public communication channels such as a public computer network (e.g., the internet). APIs, as discussed herein, may be based on any suitable API architecture. Exemplary API architectures and/or protocols include SOAP (Simple Object Access Protocol), XML-RPC, REST (Representational State Transfer), or the like.

The various processing steps, logical steps, and/or data flows depicted in the figures and described in greater detail herein may be accomplished using some or all of the system components also described herein. In some implementations, the described logical steps or flows may be performed in different sequences and various steps may be omitted. Additional steps may be performed along with some, or all of the steps shown in the depicted logical flow diagrams. Some steps may be performed simultaneously. Some steps may be performed using different system components. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the invention or portions of the system of the invention may be in the form of a “processing device,” a “computing device,” a “computer,” an “electronic device,” a “mobile device,” a “client device,” a “server,” etc. As used herein, these terms (unless otherwise specified) are to be understood to include at least one processor that uses at least one memory. The at least one memory may store a set of instructions. The instructions may be either permanently or temporarily stored in the memory or memories of the processing device. The processor executes the instructions that are stored in the memory or memories in order to process data. A set of instructions may include various instructions that perform a particular step, steps, task, or tasks, such as those steps/tasks described above, including any logical steps or logical flows described above. Such a set of instructions for performing a particular task may be characterized herein as an application, computer application, program, software program, service, or simply as “software.” In one aspect, a processing device may be or include a specialized processor. As used herein (unless otherwise indicated), the terms “module,” and “engine” refer to a computer application that executes on hardware such as a server, a client device, etc. A module or engine may be a service.

As noted above, the processing device executes the instructions that are stored in the memory or memories to process data. This processing of data may be in response to commands by a user or users of the processing device, in response to previous processing, in response to a request by another processing device and/or any other input, for example. The processing device used to implement the invention may utilize a suitable operating system, and instructions may come directly or indirectly from the operating system.

The processing device used to implement the invention may be a general-purpose computer. However, the processing device described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing device be physically located in the same geographical place. That is, each of the processors and the memories used by the processing device may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing device what to do with the data being processed.

Further, it is appreciated that the instructions or set of instructions used in the implementation and operation of the invention may be in a suitable form such that the processing device may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing device, i.e., to a particular type of computer, for example. The computer understands the machine language.

Any suitable programming language may be used in accordance with the various aspects of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing device, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing device, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing device that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing device or machines that are used to implement the invention. As used herein, a user interface includes any hardware, software, or combination of hardware and software used by the processing device that allows a user to interact with the processing device. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing device as it processes a set of instructions and/or provides the processing device with information. Accordingly, the user interface is any device that provides communication between a user and a processing device. The information provided by the user to the processing device through the user interface may be in the form of a command, a selection of data, or some other input, for example.

As discussed above, a user interface is utilized by the processing device that performs a set of instructions such that the processing device processes data for a user. The user interface is typically used by the processing device for interacting with a user either to convey information or receive information from the user. However, it should be appreciated that in accordance with some aspects of the system and method of the invention, it is not necessary that a human user actually interact with a user interface used by the processing device of the invention. Rather, it is also contemplated that the user interface of the invention might interact, i.e., convey and receive information, with another processing device, rather than a human user. Accordingly, the other processing device might be characterized as a user. Further, it is contemplated that a user interface utilized in the system and method of the invention may interact partially with another processing device or processing devices, while also interacting partially with a human user.

It will be readily understood by those persons skilled in the art that the present invention is susceptible to broad utility and application. Many aspects and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary aspects, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such aspects, adaptations, variations, modifications, or equivalent arrangements.

1. A method comprising:
receiving, at an application programming interface (API) of a middle-tier platform, an initial API method call including a request identifier associated with a processing request and a data parameter;
writing the data parameter and the request identifier to a record of a datastore, wherein the record of the datastore includes a batch field;
writing a value of false to the batch field;
executing, by a first intermediary processing procedure, a query of the datastore, wherein the query of the datastore retrieves the record of the datastore;
performing, by a second intermediary processing procedure, additional intermediary processing;
making a secondary API call to a backend system;
receiving a second data parameter from the backend system in response to the secondary API call; and
generating a response to the processing request.

2. The method of claim 1, wherein the first intermediary processing procedure is a batch process.

3. The method of claim 2, wherein the first intermediary processing procedure updates the batch field to a value of true before completing execution.

4. The method of claim 1, wherein the query of the datastore includes the request identifier and the value of false to the batch field as lookup parameters of the query.

5. The method of claim 1, wherein the initial API method call is received from a user interface.

6. The method of claim 5, wherein a user interface object is associated with the initial API method call.

7. The method of claim 6, wherein a user activation of the user interface object initiates the initial API method call.

8. A system comprising at least one computer including a processor, wherein the at least one computer is configured to:
receive, at an application programming interface (API) of a middle-tier platform, an initial API method call including a request identifier associated with a processing request and a data parameter;
write the data parameter and the request identifier to a record of a datastore, wherein the record of the datastore includes a batch field;
write a value of false to the batch field;
execute, by a first intermediary processing procedure, a query of the datastore, wherein the query of the datastore retrieves the record of the datastore;
perform, by a second intermediary processing procedure, additional intermediary processing;
make a secondary API call to a backend system;
receive a second data parameter from the backend system in response to the secondary API call; and
generate a response to the processing request.

9. The system of claim 8, wherein the first intermediary processing procedure is a batch process.

10. The system of claim 9, wherein the first intermediary processing procedure updates the batch field to a value of true before completing execution.

11. The system of claim 8, wherein the query of the datastore includes the request identifier and the value of false to the batch field as lookup parameters of the query.

12. The system of claim 8, wherein the initial API method call is received from a user interface.

13. The system of claim 12, wherein a user interface object is associated with the initial API method call.

14. The system of claim 13, wherein a user activation of the user interface object initiates the initial API method call.

15. A non-transitory computer readable storage medium, including instructions stored thereon, which instructions, when read and executed by one or more computer processors, cause the one or more computer processors to perform steps comprising:
receiving, at an application programming interface (API) of a middle-tier platform, an initial API method call including a request identifier associated with a processing request and a data parameter;
writing the data parameter and the request identifier to a record of a datastore, wherein the record of the datastore includes a batch field;
writing a value of false to the batch field;
executing, by a first intermediary processing procedure, a query of the datastore, wherein the query of the datastore retrieves the record of the datastore;
performing, by a second intermediary processing procedure, additional intermediary processing;
making a secondary API call to a backend system;
receiving a second data parameter from the backend system in response to the secondary API call; and
generating a response to the processing request.

16. The non-transitory computer readable storage medium of claim 15, wherein the first intermediary processing procedure is a batch process.

17. The non-transitory computer readable storage medium of claim 16, wherein the first intermediary processing procedure updates the batch field to a value of true before completing execution.

18. The non-transitory computer readable storage medium of claim 15, wherein the query of the datastore includes the request identifier and the value of false to the batch field as lookup parameters of the query.

19. The non-transitory computer readable storage medium of claim 15, wherein the initial API method call is received from a user interface.

20. The non-transitory computer readable storage medium of claim 19, wherein a user interface object is associated with the initial API method call, and wherein a user activation of the user interface object initiates the initial API method call.
